(19) United States
(12) Patent Application Publication
(10) Pub. No.: US 2006/0167788 A1
(43) Pub. Date: Jul. 27, 2006

(54) Method and system for broker trading in a hybrid trading system for concurrently trading securities or derivatives through both electronic and open-outcry trading mechanisms

(76) Inventors: Edward T. Tilly, Barrington, IL (US); Eileen C. Smith, Chicago, IL (US)

Correspondence Address: BRINKS HOFER GILSON & LIONE, P.O. BOX 10395, CHICAGO, IL, 60610, US

(21) Appl. No.: 11/321,062

(22) Filed: Dec. 29, 2005

Related U.S. Application Data
(63) Continuation-in-part of application No. 10/423,201, filed on Apr. 24, 2003.

(51) Int. Cl. G06Q 40/00

(52) U.S. Cl. 705/37

(57) ABSTRACT

A method of broker trading in an exchange configured for trading securities or derivatives by a combination of electronic and open-outcry trading mechanisms is disclosed. The method includes receiving an order in a public automated routing system workstation, accessing the public automated routing system workstation by a broker with a broker-specific identifier, selecting the order, indicating at least a portion of the order to be executed, booked and/or maintained by a trade engine, and transmitting the at least a portion of the order to the trade engine to be executed or booked, wherein the executed, booked and/or maintained order is marked with the broker-specific identifier by the trade engine.

### RELATED APPLICATIONS

The present patent document is a continuation-in-part of U.S. patent application Ser. No. 10/423,201 filed Apr. 24, 2003, the entirety of which is hereby incorporated by reference.

### TECHNICAL FIELD

The present disclosure relates to the trading of securities or derivatives, such as options or futures. More particularly, the present invention relates to an exchange system and method for broker trading in a system for concurrent trading of securities or derivatives through both electronic and open-outcry trading mechanisms.

### BACKGROUND

The introduction of electronic trading mechanisms into exchanges for securities and derivatives has been an ongoing process. The desire for immediacy of order execution and dissemination of information is one reason for the steady substitution to electronic mechanisms. As trading volume continues to grow, along with the accompanying need for an increasingly efficient trading environment, the move toward electronic trading mechanisms is favored.

Electronic exchanges, while efficient and nearly instantaneous, do not provide for the identification of floor brokers as is done in traditional, open outcry trading environments. In traditional, open outcry trading environments, the floor broker roams about the trading floor, and, as an agent, transacts orders on behalf of the buyers and sellers. The floor broker executes orders and obtains quotes according to instructions from the booth clerk. It is not uncommon for a floor broker to specialize in a few select securities. The specialized floor broker can therefore generally be located on the crowded trading floor in the vicinity of a certain trading panel; however, the floor broker is only effective in his or her function if he or she is free to move from panel to panel, and to different posts.

Accordingly, there is a need for an exchange system and method that can address the drawbacks of electronic exchanges as they pertain to floor brokers.

### BRIEF SUMMARY

In order to address the need for improvements on electronic trading mechanisms, a trading platform and method is disclosed herein that provides for the identification of a broker involved in the purchase or sale of securities or derivatives in an exchange.

According to a first aspect of the disclosure, a method of broker trading in an exchange configured for trading securities or derivatives by a combination of electronic and open-outcry trading mechanisms is described. The method includes receiving an order in a public automated routing system workstation, accessing the public automated routing system workstation by a broker with a broker-specific identifier, selecting the order, indicating at least a portion of the order to be executed, booked and/or maintained by a trade engine, transmitting the at least a portion of the order to the trade engine to be executed or booked, and wherein the executed, booked and/or maintained order is marked with the broker-specific identifier by the trade engine.

In another aspect of the disclosure, an automated exchange for identifying a broker in the purchase or sale of securities or derivatives in an exchange configured for trading securities or derivatives by a combination of electronic and open-outcry trading mechanisms is provided. The exchange includes a public automated routing system workstation for receiving an incoming order or quotation to trade the securities or derivatives, the public automated routing system workstation for access by a broker with a broker-specific identifier associated therewith, a trade engine comprising a processor and in communication with the public automated routing system workstation and an order routing system, the trade processor for analyzing and executing orders according to matching rules stored in a database in communication therewith, an electronic template presented at the public automated routing system workstation generated in response to a broker selecting the order or quotation, wherein the broker inputs trade information into the electronic template indicative of at least a portion of the order to be executed, booked and/or maintained by the trade engine, and wherein the trade engine marks the executed, booked and/or maintained order with the broker-specific identifier.

A more detailed explanation of the invention is provided in the following description and claims and is illustrated in the accompanying drawings.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 is a diagram of one embodiment of a hybrid exchange system merging screen-based electronic orders with traditional open-outcry floor trading.

FIG. 2 is a block diagram of one embodiment of the electronic trading engine of FIG. 1.

FIG. 3 is a block diagram of one embodiment of a method for attaching a broker-specific identifier to an electronic trade notification.

FIG. 4 is a block diagram of one embodiment of a method for attaching a broker-specific identifier to a trade with a flexible trading platform.

FIG. 5 is a block diagram of one embodiment of a method for broker trading in a hybrid trading system.

### DETAILED DESCRIPTION OF THE DRAWINGS

A system and method for the identification of a broker involved in the purchase or sale of securities or derivatives in an exchange, such as securities options is described herein. The trading mechanisms and rules described are based on providing incentives or limitations to particular classes of individuals or entities who are involved in trading at an exchange. For purposes of this specification, the following definitions will be used:

Attach—to bind, mark or otherwise associate.

Broker/dealer—person or entity registered to trade for itself and/or on behalf of others at the exchange.

Public customer—person or entity, who is not a broker/dealer, trading on their own behalf through a broker/dealer or firm registered to trade at the exchange.

Firm—entity employing persons who represent the firm, or the firm's customers, on the exchange, such as market makers, floor brokers, broker/dealers, or other industry professionals.

Market maker—professional trader registered to trade at the exchange who is required to provide liquidity to a market, for example through streaming quotes for both a bid and an offer at a particular price.

Designated primary market maker (DPM)—market maker designated by the exchange to be responsible for a fair and orderly market, and to provide continuous quotes, for a particular class of options.

Floor broker—individual who represents orders from others in a trading crowd on the floor of an exchange.

Market participant—any person or entity that can submit orders or quotes to an exchange.

In-crowd market participant (ICM)—floor broker, market maker or designated primary market maker assigned to a particular security.

Instructions—quote requests and orders, as well as quotes and executions.

Non-in-crowd market participant (non-ICM)—market participants who are not physically present on the floor of the exchange.

Class of options—all series of options related to a given underlying security, where the underlying security may be, for example, publicly traded stock of a company.

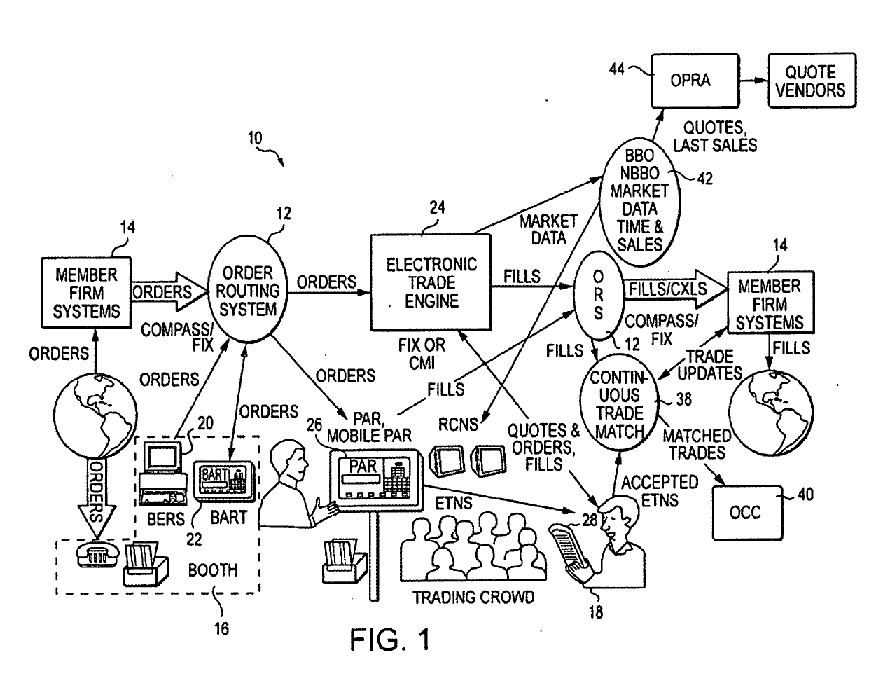

Referring to FIG. 1, one embodiment of an exchange system combining aspects of electronic, screen-based trading with traditional, open-outcry trading suitable for implementing various securities and derivatives trading methods described herein is illustrated. The system 10 receives order information for the purchase or sale of securities, for example derivatives such as stock options, from numerous sources at a central order routing system (ORS) 12. ORS 12 may be any of a number of data processing systems or platforms capable of managing multiple transactions, as are well known in the art. For example, in one embodiment, the order routing system can be implemented on a transaction processing facility (TPF) platform manufactured by IBM Corporation. For purposes of clarity, the examples herein will refer specifically to options. It should be understood that the system and methods disclosed herein might be applied to the trading of other types of securities and derivatives.

Accordingly, an exchange utilizing the system and methods described herein may manage a number of classes of derivatives, where each of the plurality of classes of derivatives are associated with an underlying asset such as a stock, a bond, a note, a future, an exchange traded fund, an index, a commodity or other known asset types.

Information, such as orders may be entered into the ORS 12 from remote member firm systems 14, from member firm's booths 16 physically located at the exchange system 10 and from market makers 18 present on the trading floor of the exchange. The member firm systems 14 may be located remotely from the geographical location of the exchange and use any of a number of standard landline or wireless communication networks to direct orders electronically to the ORS 12. The member firm systems 14 communicate with one of several interfaces or protocols for transmitting their orders to the ORS 12. Examples of suitable interfaces are those using a distributed object interface based on the CORBA standard and available from the Object Management Group. Interfaces such as financial information exchange (FIX), which is a message-based protocol implemented over TCP/IP available from FIX Protocol, Ltd., or other known securities transaction communication protocols are also suitable protocols. In some instances, orders may even be made by telephone calls or facsimile transmissions directly to the booths 16 of member firms at the exchange. Orders submitted from a booth 16 at the exchange may come from a booth entry and routing system (BERS) 20 or a booth automated routing terminal (BART) 22.

The BERS 20 is a computer workstation that provides firm staff members at the booth with an entry template and a graphic user interface with a number of function buttons arranged on the display. Orders entered at the booth through BERS 20 typically consist of orders that were telephoned to the booth and orders that were wired to member firm-owned house printers in the booth. The orders entered through BERS are done so manually by booth staff using an order template and graphic user interface on the workstation. Generally, an order entered at BERS 20 will be routed to the ORS 12. Member firms, however, may specify that a particular order entered through BERS be routed to the BART 22 device. The BART 22 device, sometimes referred to as the “electronic runner,” allows member firms to maintain more control over their order flow. BART 22 allows each firm to customize certain ORS 12 parameters to route a certain portion of their order flow to the firm booth. For example, firms may instruct ORS 12 to send certain orders directly to their booths 16 based on the size of the order.

As with the BERS 20, BART 22 may be implemented on a touch-screen workstation located in the member firm booth. The BART 22 operator at the booth may electronically forward orders to desired destinations. Potential destinations for these booth-routed orders are the ORS 12, the electronic trade engine 24 in communication with the ORS 12, or the public automated routing (PAR) system 26 used by the floor brokers at the exchange. The PAR system 26 may be implemented as a PC-based, touch-screen order routing and execution system accessible by floor brokers on the floor of the exchange.

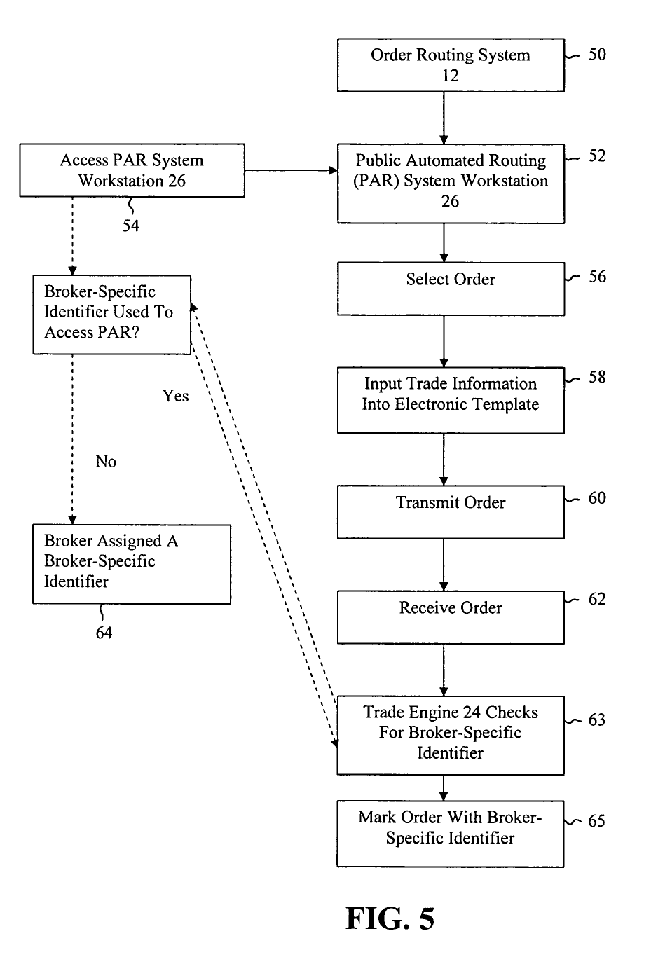

Typically, the PAR system 26 will be accessible by a floor broker inputting a broker-specific identifier therein. The broker-specific identifier is preferably a personal identification number (PIN) or other coded identifier known and specific to the floor broker. Once accessed by the floor broker, the PAR system 26 terminals, for example, allow a floor broker to select an order from the workstation and receive an electronic trading card or template on which the floor broker may enter trade information such as its volume, price, opposing market makers, or the like. In particular, in one embodiment, the floor broker indicates at least a portion of the selected order that is to be executed or booked by the trade engine 24. When a floor broker completes an electronic template, the floor broker can then initiate the execution of a trade electronically with the touch of a finger on the touch screen interface. In one embodiment, the PAR system 26 then transmits the completed order, also referred to as a “fill,” back to the ORS 12. The ORS 12 can then mark the completed order with the broker's broker-specific identifier. In another embodiment, the PAR system 26 transmits to the trade engine 24 the portion of the selected order indicated by the floor broker to be executed or booked by the trade engine 24, with the trade engine 24 marking the portion of the order to be executed or booked with the broker-specific identifier, as further detailed with reference to FIG. 5 below, to associate a particular order with a specific broker. This benefits the broker by permitting the trade engine 24 to indicate which orders were handled on behalf of a particular broker so that a charge may be passed on to the broker's customer represented by the order executed by the trade engine 24. The PAR 26 may be a fixed workstation, a mobile workstation, or any other device known in the art.

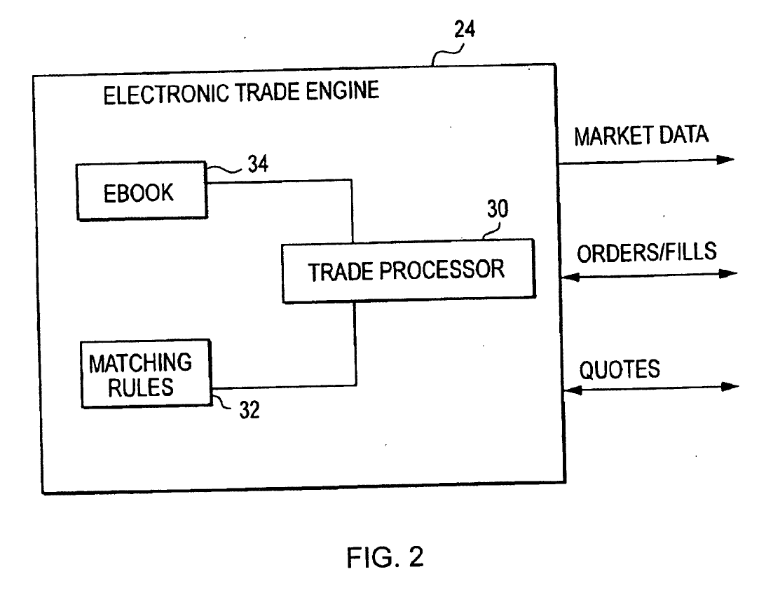

As illustrated in FIG. 2, the electronic trade engine 24 contains a trade processor 30 that analyzes and executes orders according to matching rules 32 stored in the database in communication with the trade processor 30, as described in copending U.S. patent application Ser. No. 10/423,201, the entirety of which is hereby incorporated by reference. Also included in the electronic trade engine is the electronic book (EBOOK) 34 of orders and quotes with which incoming orders to buy or sell are matched with quotes and orders resting on the EBOOK 34 according to the matching rules 32. In one embodiment, upon a match, the electronic trade engine 24 will mark the matched order or quote with the broker-specific identifier so that the broker sending the order or quote information can be identified. The electronic trade engine 24 may be a stand-alone or distributed computer system. Any of a number of hardware and software combinations configured to execute the trading methods described below may be used for the electronic trade engine 24. In one embodiment, the electronic trade engine 24 may be a server cluster consisting of servers available from Sun Microsystems, Inc., Fujitsu Ltd. or other known computer equipment manufacturers. The EBOOK 34 portion of the electronic trade engine 24 may be implemented with Oracle database software and may reside on one or more of the servers comprising the electronic trade engine 24. The rules database 32 may be C++ or java-based programming accessible by, or executable by, the trade processor 30.

When a trade is completed, whether on the floor in open outcry and entered into PAR 26 or automatically executed through the electronic trade engine 24, the fill information is sent through the ORS 12 and the electronic trade engine 24, where the broker-specific identifier is attached to the fill information so that the fill information is associated with a specific broker. This enables the broker to pass charges for the trade executed by the trade engine 24, since the executed order is representative of a customer and marked by the trade engine 24 with the broker-specific identifier. ORS 12 passes the fill information to the member firm systems and to a continuous trade match (CTM) system 38 which matches the buy side and sell side of a trade which, in turn, forwards the matched trades to the Options Clearing Corporation (OCC) 40, a third party organization that will verify that all trades properly clear. The electronic trade engine 24 also sends quote and sale update information through an internal distribution system 42 that will refresh display screens within the exchange 10 and format the information for submission to a quote dissemination service such as the Options Price Reporting Authority (OPRA) 44.

For the purposes of illustration, examples 1 through 3 are set forth below. In each of the examples, it is assumed that a PAR unit associated with a broker receives orders through the ORS and that the PAR unit is accessed by a broker using a broker-specific identifier.

### EXAMPLE 1

### Open Outcry

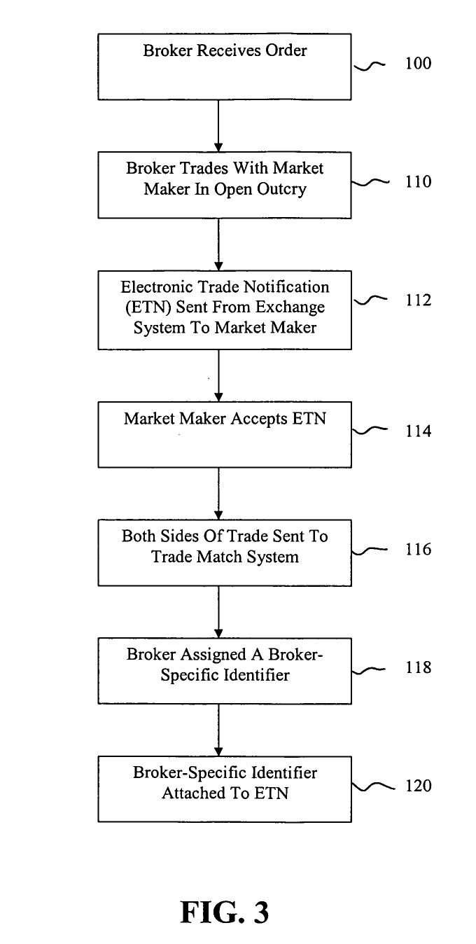

Referring now to FIG. 3, once the broker has received an order on PAR 26 he can trade in open outcry with market makers in the crowd. As illustrated in FIG. 3, the broker receives an order on PAR 26 (step 100), and then trades with at least one market maker in open outcry (step 110). The system will automatically generate an electronic trade notification (ETN) that is sent from the exchange, such as CBOE, to the market maker's hand-held provider (step 112). The market maker accepts the ETN (step 114) and both sides of the trade are sent to the trade match system (step 116). At the trade match system, the broker may be assigned a broker-specific identifier (step 118), with the broker-specific identifier thereby attached to the ETN (step 120). The broker-specific identifier may be attached to the ETN by the order routing system 12, trade engine 24, PAR 26, continuous trade matching system 38 or any other system or device known in the art to associate a user-specific identifier with other information.

### EXAMPLE 2

### Order Book

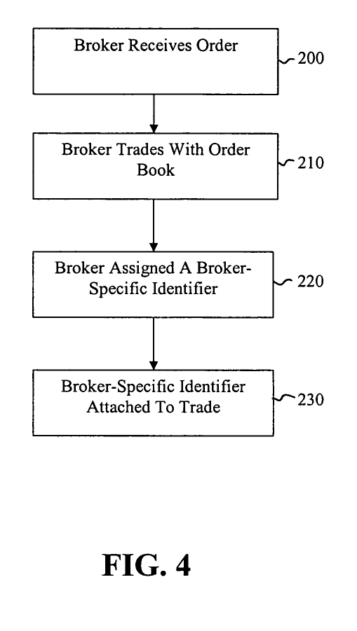

Referring now to FIG. 4, once the broker has received an order on PAR 26 (step 200) he can trade all or part of the order with the order book (step 210), where the order book is comprised of Public Customers and Broker-Dealers. If Public Customer priority is available in the system the broker can choose to trade with the Public Customer portion only. If Public Customer priority is not available in the system, then the broker can only trade in accordance with the algorithm present in the system. At the trade match system, the broker may be assigned a broker-specific identifier (step 220), with the broker-specific identifier thereby attached to the trade (step 230). Thus, the trade is marked with the broker-specific identifier, attributing it to the broker so that he can retain billing rights for the trade. The broker-specific identifier may be attached to the trade by the order routing system 12, trade engine 24, PAR 26, continuous trade matching system 38 or any other system or device known in the art to associate a user-specific identifier with other information.

Additionally, once the broker has received an order on PAR 26 he can trade all or part of the order with the top-of-the-market on a flexible trading platform, such as CBOEdirect™, where the top-of-the-market includes the order book 34, as well as the quotes provided by market makers. When the broker trades with orders and/or quotes in CBOEdirect™, the trade may be marked with the broker-specific identifier by the flexible trading platform, attributing it to the broker so that he can retain billing rights for the trade.

### EXAMPLE 3

### Retention Of Billing Rights For The Trade

Once the broker has received an order on PAR he can represent all or part of an order in the exchange's top-of-the-market while still retaining billing rights for the trade. This is accomplished by: 1) Booking the order with an indication that the broker is responsible for that order; 2) Booking part of the order but retaining the remainder of the order on PAR so that it can be traded in open outcry; 3) Creating a new order on the PAR workstation called a reserve order where the broker can choose to have a portion of the order represented as part of the market. The order would be routed to the CBOEdirect™ book and CBOEdirect™ would “manage” the order including trading all or a portion of it when hit by another order or quote, and displaying more of the order when the displayed portion was decreased below the reserve amount. For example, the broker has a 1000 lot order but only wants 200 displayed. If an order came in to trade against the booked order, the booked order could trade up to the full 1000 contracts. A value of zero for display is acceptable and the incoming order would just get filled at a price that is better than the displayed market. If the first 200-lot gets traded out than 200 more would be shown immediately.

Further, in an embodiment, using RFP/RFQ functionality, a broker sends an order marked for RFQ or RFP to the flexible trading platform, such as CBOEdirect, in order to solicit private interest. All responses are private. The broker chooses whether he wants to have an RFQ sent by the system (the system would not disclose the side of the market that the order is on) or an RFP sent (the system would disclose the side an the minimum acceptable price).

Utilizing the system described above, a hybrid trading system retaining the benefits of traditional floor-based open-outcry exchanges and incorporating the efficiency of traditional electronic trading systems may be implemented. In one embodiment, the electronic trade engine 24 receives all quote and/or order information and identifies the source of the quote or order before allowing the quote or order to trade with, or be placed on, the EBOOK 34. This filtering is preferably accomplished by verifying market maker- and/or broker-specific identification information embedded with quote and/or order information, for example through appending a unique identifier associated with the broker or market maker to an order, or by only accepting quotes from terminals or workstations identifiable as on the premises of the exchange. In one implementation, each market maker is logged into the exchange such that every communication from the market maker to the exchange will be identified based on the login information associated with that market maker. In another implementation, each floor broker is logged into the PAR 26 such that communications from the floor broker to the exchange will be identified based on the login information associated with that floor broker.

When an order is received at the ORS 12, the ORS 12 determines whether it qualifies for routing to the electronic trade engine 24. The ORS 12 examines both the order size and price. If the order price is at the market, it may be sent directly to the electronic trade engine for immediate execution. However, each order is also screened based on a two-tier order size analysis. First, the exchange may set a default auto-execution limit such that any amount of the order exceeding that size limit will be routed to the PAR system 26 for open-outcry trading on the floor of the exchange. Second, even if some or all of the order is within the exchange default size limit, each firm or broker may have a separate customized routing instruction that takes precedence over the exchange limit so that some or all of the order that would qualify for auto execution will be routed else where. For example, the firm or broker from whom the order originated may have previously instructed the ORS 12 to have their orders routed first to their booth 16 for more detailed handling.

After passing through the ORS 12, the trade processor 30 checks to see if the incoming order is immediately marketable against orders and quotes resting in the EBOOK 34. If the order price on the incoming order to buy or sell matches a counterpart offer to sell or buy on the EBOOK 34, then the order is considered marketable and the trade processor 30 looks at the matching rules database 32 to determine allocation of the incoming electronic order among the various counterpart quotes and orders on the EBOOK 34.

According to one embodiment of the method, as illustrated in FIG. 5, the ORS 12 sends an order to be received at the Public Automated Routing system workstation (PAR 26) (at steps 50, 52). The floor broker accesses the PAR 26 with a broker-specific identifier (at step 54). The floor broker selects an order that is listed on the PAR 26 (at step 56). Upon and in response to selecting the order, the floor broker receives an electronic template for the inputting of trade information by the floor broker, which may include volume, price, opposing market makers, or the like. In particular, in one embodiment the floor broker indicate at least a portion of the selected order that is to be executed or booked by the trade engine 24. The floor broker inputs trade information into the electronic template (at step 58) and transmits at least a portion of the order to the trade engine 24 (at step 60) for execution or booking. Upon receiving the order (at step 62), the trade engine 24 then checks to determine for a pre-existing broker-specific identifier (step 63), such as if a broker-specific identifier was used to access PAR 26. Such a pre-existing broker-specific identifier may be entered manually into an order template or automatically populate an order template. If no pre-existing broker-specific identifier exists, then a broker-specific identifier is assigned to the broker (step 64) by the trade engine 24. The trade engine 24 then attaches or otherwise marks the executed or booked order with the broker-specific identifier (at step 65). Alternatively, the broker-specific identifier may be generated and/or attached to the order by the order routing system 12, PAR 26, continuous trade matching system 38 or any other system or device known in the art to associate a user-specific identifier with other information.

As has been described above, the hybrid exchange system merges electronic and open outcry trading models while at the same time offering certain market participants the ability to retain billing rights for the trade.

Although the system and methods described herein relate to a hybrid system incorporating and involving active participation from a trading floor and a screen-based electronic trading crowd, many of the procedures described may be applied to an exclusively electronic, screen-based exchange that does not include floor based, open-outcry trading. As will be appreciated by those of ordinary skill in the art, mechanisms for the marking of information with the broker-specific identifier and other features described above may all be modified for application to electronic-only trading within the purview and scope of the present invention.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. It is therefore intended that the foregoing detailed description be regarded as illustrative rather than limiting, and that it be understood that it is the following claims, including all equivalents, that are intended to define the scope of this invention.

1. A method of broker trading in an exchange operative to trade securities or derivatives by a combination of electronic and open-outcry trading mechanisms, the method comprising:
receiving an order in a public automated routing system workstation;
receiving a broker-specific identifier;
receiving a selection of the order;
receiving an indication of at least a portion of the order to be executed or booked by a trade engine; and
transmitting the at least a portion of the order to the trade engine to be executed or booked, and to be marked with the broker-specific identifier.

2. The method according to claim 1 wherein the public automated routing system workstation receives the order from an order routing system.

3. The method according to claim 1 wherein the broker-specific identifier is a personal identification number.

4. The method according to claim 1 wherein the broker-specific identifier is received from a broker attempting to gain access to the public automated routing system workstation.

5. An exchange for identifying a broker in a purchase or sale of securities or derivatives, the exchange operative to trade securities or derivatives by a combination of electronic and open-outcry trading mechanisms, the exchange comprising:
a public automated routing system workstation operative to receive an incoming order or quotation to trade at least one security or derivative, and operative to receive a broker-specific identifier;
a trade engine in communication with the public automated routing system workstation, the trade engine operative to analyze and execute orders according to matching rules; and
an electronic template presented at the public automated routing system workstation for a broker to input trade information indicative of at least a portion of the order to be executed or booked by the trade engine;
wherein the trade engine marks the executed or booked order with the broker-specific identifier.

6. The exchange according to claim 5, wherein the broker-specific identifier is a personal identification number.

7. The exchange according to claim 6, wherein the public automated routing system workstation receives the broker-specific identifier from the broker when the broker attempts to gain access to the public automated routing system workstation.

8. The exchange according to claim 5, wherein the trade information further comprises volume data.

9. The exchange according to claim 5, wherein the trade information further comprises price data.

10. The exchange according to claim 5, wherein the trade information further comprises opposing market maker data.

11. The exchange according to claim 5, wherein the trade engine is in further communication with an order routing system.

12. The exchange according to claim 5, wherein the trade engine comprises a trade processor and the trade processor is operative to analyze and execute orders according to matching rules.

13. The exchange according to claim 12, wherein the matching rules are stored in a database in communication with the trade engine.

14. The exchange according to claim 5, wherein the electronic template is generated in response to the broker selecting the order or quotation.
